(19) United States
(12) Patent Application Publication
(10) Pub. No.: US 2013/0217611 A1
(43) Pub. Date: Aug. 22, 2013

(54) Biodegradable Quaternary Compounds as Emulsifiers for Microemulsions

(71) Applicant: Eduardo Caballero, Bethlehem, PA (US)

(72) Inventor: Eduardo Caballero, Bethlehem, PA (US)

(73) Assignee: COGNIS IP MANAGEMENT GMBH, Dusseldorf (DE)

(21) Appl. No.: 13/882,379

(22) PCT Filed: Sep. 22, 2011
(86) PCT No.: PCT/EP11/04734

§ 371 Date: Apr. 29, 2013

Related U.S. Application Data
(60) Provisional application No. 61/408,807, filed on Nov. 1, 2010.

(51) Int. Cl. C11D 1/62

(52) U.S. Cl. CPC C11D 1/62
USPC 510/417

(57) ABSTRACT

The present invention pertains to the use of cationic surfactants corresponding to formula (I): in which R is an alkyl or alkenyl group containing II carbon atoms, R1 and R2 independently represent hydrogen or C₁₋₄ alkyl, R³ is a C₁₋₄ alkyl group, R⁴ is hydrogen or methyl, A is a linear or branched C₂₋₆ alkylene group, n is a number from 1 to 25, and X is halogen or alkyl sulfate. Compounds of formula (I) are useful as emulsifiers for aqueous microemulsions containing terpenes.

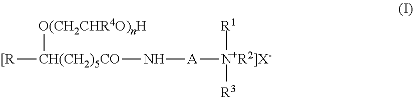

### FIELD OF THE INVENTION

The invention relates to biodegradable quaternary compounds for the use as emulsifiers in terpene-microemulsions.

### BACKGROUND OF THE INVENTION

General purpose household cleaning compositions for hard surfaces such as metal, glass, ceramic, plastic and linoleum surfaces are commercially available in both powdered and liquid form. Powdered cleaning compositions consist mainly of builder or buffering salts such as phosphates, carbonates, and silicates and although such compositions may display good inorganic soil removal, they exhibit inferior cleaning performance on organic soils such as greasy/fatty/oily soils.

Liquid cleaning compositions, on the other hand, have the great advantage that they can be applied to hard surfaces in neat or concentrated form so that a relatively high level of surfactant material is delivered directly to the soil. Moreover, it is a rather more straightforward task to incorporate high concentrations of anionic or nonionic surfactant in a liquid rather than a granular composition. For both of these reasons, therefore, liquid cleaning compositions have the potential to provide superior grease and oily soil removal versus powdered cleaning compositions.

Microemulsions are known way to provide such cleaning compositions, see U.S. Pat. No. 5,213,624, for example. By providing emulsions, obviously an emulsifying agent is needed. While many suitable compounds are known, there is a constant need to provide new kinds of emulsifiers, which show good emulsification properties, but are also biodegradable, and preferably based on renewable resources.

### BRIEF SUMMARY OF THE INVENTION

It was surprisingly found that a selected cationic emulsifier meets these requirements.

Microemulsions, particularly of terpene hydrocarbons such as d-limonene and pine oil, are difficult to prepare even with conventional surfactants. Surfactants such as alkylphenol ethoxylates and quaternary ammonium compounds are known to be effective microemulsifiers as described in U.S. Pat. No. 4,336,151, U.S. Pat. No. 4,336,152 U.S. Pat. No. 4,455,250 and U.S. Pat. No. 4,511,488 respectively. However, alkylphenol ethoxylates and quaternary ammonium compounds degrade very slowly and can persist in the environment. Also, prior art terpene microemulsions typically employ 3 or more emulsifiers and co-solvents to prepare a stable microemulsion as disclosed in U.S. Pat. No. 4,336,151.

It has been surprisingly found that stable microemulsions can be prepared using a selected quaternary ammonium compound of the invention. It has also been surprisingly found that simple emulsifier packages containing the novel quaternary ammonium compound and a second co-emulsifier is all that is required to prepare a microemulsion containing a wide variety of terpene hydrocarbon percentages. Also, unlike prior art microemulsifier packages, all of the emulsifiers used in present invention degrade readily and meet the biodegradability requirements of EC No. 648/2004 on detergents.

### DETAILED DESCRIPTION OF THE INVENTION

In a first embodiment the present invention pertains to a microemulsion composition comprising: (a) a primary emulsifier selected from a compound according to formula (I)

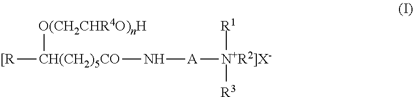

in which R is an alkyl or alkenyl group containing 11 carbon atoms, R1 and R2 independently represent hydrogen or C₁₋₄ alkyl groups, R³ is a C₁₋₄ alkyl group, R⁴ is hydrogen or a methyl group, A is a linear or branched C₂₋₆ alkylene group, n is a number from 1 to 25, and X is halogen or alkyl sulfate; (b) a terpene; optionally (c) a polar solvent; optionally (d) a secondary emulsifier; and (e) the remainder, water and optionally other additives to 100 wt %, all weights being based on the total weight of the composition.

The biodegradable cationic compounds according to formula (I) are known from US 2006/0079435, where also a method for preparing such compounds is disclosed. Although US 2006/0079435 describes hard surface cleaning compositions comprising compounds according to general formula (I) this document does not disclose the use of said compounds in terpene-containing microemulsions.

Microemulsions are clear, stable, isotropic liquid mixtures of oil, water and surfactant, frequently in combination with a co-surfactant. The aqueous phase may contain salt(s) and/or other ingredients, and the “oil” may actually be a complex mixture of different hydrocarbons and olefins. In contrast to ordinary emulsions, microemulsions form upon simple mixing of the components and do not require the high shear conditions generally used in the formation of ordinary emulsions. The two basic types of microemulsions are direct (oil dispersed in water, o/w) and reversed (water dispersed in oil, w/o). Without wishing to be bound by any particular theory, it is understood that in ternary systems such as microemulsions, where two immiscible phases (water and ‘oil’) are present with a surfactant, the surfactant molecules may form a monolayer at the interface between the oil and water, with the hydrophobic tails of the surfactant molecules dissolved in the oil phase, and the hydrophilic head groups in the aqueous phase. As in the binary systems (water/surfactant or oil/surfactant), self-assembled structures of different types can be formed, ranging, for example, from (inverted) spherical and cylindrical micelles to lamellar phases and bicontinuous microemulsions, which may coexist with predominantly oil or aqueous phases. Microemulsions are optically transparent and thermally stable. Microemulsions show typically a droplet size in the range from 3 to 100 nm. The microemulsion compositions of the present invention are present with advantage in the form of an oil-continuous microemulsion.

The quaternized alkylamines of general formula (I) are derived preferably from ethoxylated castor oil, ethoxylated ricinoleic acid or ethoxylated 12-hydroxystearic acid. Furthermore, quaternized alkylamines of formula (I) are preferably selected, wherein R¹, R² and R³ in formula (I) are methyl groups. A further embodiment pertains to such quaternized alkylamines of formula (I) which are selected, wherein A is a propylene group. It is further of advantage if a quaternized alkylamine of formula (I) is selected wherein n is a number from 5 to 10. Also preferred are such quaternized alkylamines of formula (I), wherein X is chloride or methyl sulfate.

A second embodiment of the present invention pertains to an aqueous microemulsion composition comprising: (a) from about 1 to about 25% by weight of a primary emulsifier selected from a compound according to formula (I); (b) from about 3 to about 50% by weight of a terpene; and (c) from about 1 to about 10% by weight of a solvent; (d) optionally a secondary emulsifier; (e) the remainder, water and optionally other additives to 100%, all weights being based on the total weight of the composition.

Microemulsions which comprise the primary emulsifier in an amount of from about 10 to about 20 wt % are preferred.

The microemulsions contain optionally, but preferably, a polar solvent selected from the group consisting of ethanol, benzyl alcohol, propylene glycol n-butyl ether, n-hexanol, glycol phenyl ethers, and mixtures thereof. Other suitable solvents are selected from the group of C1-C4 alkyl esters of saturated or unsaturated C6-C22 carboxylic acids, such as, for example, the methyl ester of a C8-C10 carboxylic acid. The preferred non-polar solvent is ethanol.

The polar solvent can be present in amounts from about 0.5 to 10 wt %, preferably in amounts from 1 to 5 wt %. The non-polar solvent is an optional component, and therefore it is also an object of the present invention to provide microemulsions free of non-polar solvent.

A second class of solvents is selected from dibasic esters. Dibasic esters are generally defined as dialkyl esters of dicarboxylic acids capable of undergoing reactions at the ester group, including both hydrolysis and saponification. The acid portion of the dibasic ester may be derived from dibasic acids such as, adipic, glutaric, oxalic, malonic, pimelic, suberic and azelaic acids, as well as mixtures thereof.

A required ingredient of the microemulsions is at least one terpene. Preferably sesquiterpenes are chosen. In a preferred embodiment the terpene is selected from the group consisting of d-limonene from natural and artificial sources, dl-limonene, pine oil, lemon oil, orange oil, grapefruit oil, lime oil, and bergamot oil. It is one object of the present invention to provide formulations which contain high amounts of such terpenes in emulsified stable form. Preferably, the compositions according to the present invention contain terpenes in amounts from 3 to 50 wt %, preferably 5 to 45 wt %, and more preferably in amounts from 10 to 30 wt %.

A further required component is water, which is present in amounts from about 10 to about 90 wt %, and preferably from 45 to 65 wt %.

The microemulsions may further comprise additives, selected from the group of additional emulsifiers, co-surfactants, pH-adjusting agents, abrasives, biocides, dyes, perfumes, fatty acids, and thickeners.

Suitable additional emulsifiers which could be used together with the cationic primary emulsifier according to the general formula (I) are, for example, nonionic surfactants from at least one of the following groups:
products of the addition of 2 to 30 mol ethylene oxide and/or 0 to 5 mol propylene oxide onto linear C₈₋₂₂ fatty alcohols, C₁₂₋₂₂ fatty acids, alkyl phenols containing 8 to 15 carbon atoms in the alkyl group and alkylamines containing 8 to 22 carbon atoms in the alkyl group;
alkyl and/or alkenyl oligoglycosides containing 8 to 22 carbon atoms in the alk(en)yl group and ethoxylated analogs thereof;
products of the addition of 1 to 15 mol ethylene oxide onto castor oil and/or hydrogenated castor oil;
products of the addition of 15 to 60 mol ethylene oxide onto castor oil and/or hydrogenated castor oil;
partial esters of glycerol and/or sorbitan with unsaturated, linear or saturated, branched fatty acids containing 12 to 22 carbon atoms and/or hydroxycarboxylic acids containing 3 to 18 carbon atoms and addition products thereof with 1 to 30 mol ethylene oxide;
partial esters of polyglycerol (average degree of self-condensation 2 to 8), polyethylene glycol (molecular weight 400 to 5,000), trimethylolpropane, pentaerythritol, sugar alcohols (for example sorbitol), alkyl glucosides (for example methyl glucoside, butyl glucoside, lauryl glucoside) and polyglucosides (for example cellulose) with saturated and/or unsaturated, linear or branched fatty acids containing 12 to 22 carbon atoms and/or hydroxycarboxylic acids containing 3 to 18 carbon atoms and addition products thereof with 1 to 30 mol ethylene oxide;
mixed esters of pentaerythritol, fatty acids, citric acid and fatty alcohol and/or mixed esters of fatty acids containing 6 to 22 carbon atoms, methyl glucose and polyols, preferably glycerol or polyglycerol;
mono-, di- and trialkyl phosphates and mono-, di- and/or tri-PEG-alkyl phosphates and salts thereof;
wool wax alcohols;
polysiloxane/polyalkyl/polyether copolymers and corresponding derivatives;
block copolymers, for example Polyethyleneglycol-30 Dipolyhydroxystearate;
polymer emulsifiers, for example Pemulen types (TR-1, TR-2) from Goodrich;
polyalkylene glycols and
glycerol carbonate.

Co-surfactants, for use with the microemulsions may be selected from nonionic, anionic, cationic (other than the compounds according to formula (I), and amphoteric surfactants.

Anionic surfactants may include, but are not limited to, water-soluble salts of alkyl benzene sulfonates, alkyl sulfates, alkyl polyethoxy ether sulfates, paraffin sulfonates, alpha-olefin sulfonates and sulfosuccinates, alpha-sulfocarboxylates and their esters, alkyl glyceryl ether sulfonates, fatty acid monoglyceride sulfates and sulfonates, and alkyl phenol polyethoxyether sulfates.

Other suitable water-soluble anionic surfactants include the water-soluble salts or esters of alpha-sulfonated fatty acids containing from about 6 to about 20 carbon atoms in the fatty acid group and from about 1 to about 10 carbon atoms in the ester group.

The anionic surfactant employed by the present invention comprises with advantage a monoethanolamine salt of a sulfonic acid formed by reacting monoethanolamine with an alkyl sulfonic acid, in a ratio by weight of from 1:4 to 1:6, and most preferably 1:5, resulting in complete neutralization of the alkyl sulfonic acid. It is employed for example in an amount of from about 1.0 to about 15.0 wt %, preferably from about 5.0 to about 12.0 wt %, and most preferably from about 7.0 to about 10.0 wt %, based on the weight of the total composition.

Particularly preferred anionic co-surfactants for use in the present invention include the monoisopropanolamine salts.

A further feature of the present invention is the co-use of amide surfactants as secondary emulsifier in the microemulsion composition. Generally, amides have been considered as suds boosters to be used to supplement a variety of surfactants such as anionic, nonionic, amphoteric, and zwitterionic surfactants. It has been found, however, that the amide co-surfactant in the present invention, used as secondary emulsifier surprisingly provides a cleaning performance comparable to a cleanser using well-known anionic and nonionic surfactants as the primary surfactant.

The amide co-surfactant used in the present invention includes the ammonia and the C2-C4 alkanol amides of fatty acids having an acyl moiety of from about 8 to about 18 carbon atoms. These acyl moieties may be derived not only from naturally occurring glycerides, e.g. coconut oil, palm oil, soybean oil and tallow, but also can be derived synthetically, e.g. by the oxidation of petroleum or by the hydrogenation of carbon monoxide by the Fischer-Tropsch process. The monoethanol and diethanol amides of C10-C14 fatty acids are preferred. The diethanolamide of coconut fatty acid is most preferred.

Generally, the amide co-surfactant used as secondary emulsifier can be added in amounts ranging from about 1% to about 25 wt %, preferably from about 1 wt % to about 15 wt %. More preferably, the amide surfactant is added in an amount of about 2 wt % to about 10 wt %.

Alkyl ether sulfates are generally defined as salts of sulfated adducts of ethylene oxide with fatty alcohols containing from about 8 to about 18 carbon atoms. The alkyl ether sulfates which may be employed in the present invention are commercially available and generally contain a linear aliphatic group having from about 8 to about 18 carbon atoms, depending on the hydrocarbon starting material used to form the surfactants. The degree of ethoxylation is from 1 to about 10 moles of ethylene oxide, and preferably about 3 moles of ethylene oxide. A particularly preferred alkyl ether sulfate is based on a C12/14/16 coconut fatty alcohol midcut.

Typical examples of nonionic surfactants are fatty alcohol polyglycol ethers, alkylphenol polyglycol ethers, fatty acid polyglycol esters, fatty acid amide polyglycol ethers, fatty amine polyglycol ethers, alkoxylated triglycerides, mixed ethers and mixed formals, optionally partly oxidized alk(en)yl oligoglycosides or glucuronic acid derivatives, fatty acid-N-alkyl glucamides, protein hydrolyzates (particularly wheat-based vegetable products), polyol fatty acid esters, sugar esters, sorbitan esters, polysorbates and amine oxides. If the nonionic surfactants contain polyglycol ether chains, they may have a conventional homolog distribution, although they preferably have a narrow-range homolog distribution.

Nonionic surfactants which could be used as co-surfactants according to the present invention are selected from alkoxylated fatty alcohols, alkoxylated fatty acids or fatty acid ester, hydroxy mixed ethers and alkyl(oligo)glycosides and mixtures thereof. Nonionic surfactants are generally characterized by carrying no discrete charge when dissolved in an aqueous medium. Representative groups of nonionic surfactants include, but are not limited to, linear alcohol ethoxylates, carboxylic acid esters, carboxylic amides, polyalkylene oxide block copolymers, and alkyl glycosides. Particularly preferred nonionic surfactants include linear fatty alcohol ethoxylates and alkyl polyglycosides.

Preferred fatty alcohol ethoxylates are derived from linear C8-C20 fatty alcohols ethoxylated with from 1 to about 25 moles of ethylene oxide. A particularly preferred fatty alcohol ethoxylate is a C12/14/16 coconut fatty alcohol midcut containing 3 moles of ethylene oxide. Particularly suitable nonionic detergents are the condensation products of a higher alcohol containing about 8 to 18 carbon atoms in a straight or branched-chain configuration condensed with about 0.5 to 30, preferably 2 to 10, moles of ethylene oxide. A particularly preferred compound is C9-C11 alkanol ethoxylate (5EO) which also is abbreviated C9-C11 alcohol EO 5:1 and C12-C15 alkanol ethoxylate (7EO) which also is abbreviated as C12-C15 alcohol EO 7:1. These preferred compounds are commercially available from Shell Chemical Co. under the tradenames DOBANOL® 91-5 and NEODOL® 25-7.

The alkyl polyglycosides which can be used in the surfactant mixture according to the present invention correspond to formula (II):

R′O(R″O)_{b}(Z)ₐ (II)

wherein R′ is a monovalent organic radical having from about 6 to about 30 carbon atoms, once again depending on which starting material is used; R″ is a divalent alkylene radical having from 2 to 4 carbon atoms; Z is a saccharide residue having 5 or 6 carbon atoms; b is a number having a value from 0 to about 12; a is a number having a value from 1 to about 6. Preferred alkyl polyglycosides which can be used in the compositions according to the invention have the formula (II) wherein Z is a glucose residue and b is zero. Such alkyl polyglycosides are commercially available, for example, as APG®, GLUCOPON®, or PLANTAREN® surfactants from Henkel Corporation, Ambler, Pa., 19002.

Other examples include alkyl polyglycoside surfactant compositions which are comprised of mixtures of compounds of the formula before wherein Z represents a moiety derived from a reducing saccharide containing 5 or 6 carbon atoms; a is a number having a value from 1 to about 6; b is zero; and R′ is an alkyl radical having from 8 to 20 carbon atoms. The compositions are characterized in that they have increased surfactant properties and an HLB in the range of about 10 to about 16 and a non-Flory distribution of glycosides, which is comprised of a mixture of an alkyl monoglycoside and a mixture of alkyl polyglycosides having varying degrees of polymerization of 2 and higher in progressively decreasing amounts, in which the amount by weight of polyglycoside having a degree of polymerization of 2, or mixtures thereof with the polyglycoside having a degree of polymerization of 3, predominate in relation to the amount of monoglycoside, said composition having an average degree of polymerization of about 1.8 to about 3. Such compositions, also known as peaked alkyl polyglycosides, can be prepared by separation of the monoglycoside from the original reaction mixture of alkyl monoglycoside and alkyl polyglycosides after removal of the alcohol. This separation may be carried out by molecular distillation and normally results in the removal of about 70-95 percent by weight of the alkyl monoglycosides. After removal of the alkyl monoglycosides, the relative distribution of the various components, mono- and poly-glycosides, in the resulting product changes and the concentration in the product of the polyglycosides relative to the monoglycoside increases as well as the concentration of individual polyglycosides to the total, i.e. DP2 (degree of polymerization=2) and DP3 (degree of polymerization=3) fractions in relation to the sum of all DP fractions. Such compositions are disclosed in U.S. Pat. No. 5,266,690 the entire content of which is incorporated herein by reference.

Other alkyl polyglycosides which can be used in the compositions according to the invention are those in which the alkyl moiety contains from 6 to 18 carbon atoms in which the average carbon chain length of the composition is from about 9 to about 14 comprising a mixture of two or more of at least binary components of alkylpolyglycosides, wherein each binary component is present in the mixture in relation to its average carbon chain length in an amount effective to provide the surfactant composition with the average carbon chain length of about 9 to about 14 and wherein at least one, or both binary components, comprise a Flory distribution of polyglycosides derived from an acid-catalyzed reaction of an alcohol containing 6-20 carbon atoms and a suitable saccharide from which excess alcohol has been separated.

The preferred alkyl polyglycosides are those of formula (II) wherein R′ is based on a coconut fatty alcohol midcut corresponding to a monovalent organic radical having a C12/14/16 carbon chain length distribution; b is zero; and Z is a glucose residue.

Hydroxy mixed ethers (HMEs) are known nonionic surfactants with a nonsymmetrical ether structure and a content of polyalkylene glycols which are obtained, for example, by subjecting olefin epoxides to a ring opening reaction with fatty alcohol polyglycol ethers. Corresponding products and their use in the cleaning of hard surfaces are the subject of, for example, European patent EP 0 693 049 B1 and International patent application WO 94/22800 (Olin) and the documents cited therein.

Typical examples of cationic surfactants other than compounds according to formula (I) are quaternary ammonium compounds, for example dimethyl distearyl ammonium chloride, and esterquats, more particularly quaternized fatty acid trialkanolamine ester salts. Typical examples of amphoteric or zwitterionic surfactants are alkylbetaines, alkylamidobetaines, aminopropionates, aminoglycinates, imidazolinium betaines and sulfobetaines. The surfactants mentioned are all known compounds. Typical examples of particularly suitable mild, i.e. particularly dermatologically compatible, surfactants are fatty alcohol polyglycol ether sulfates, monoglyceride sulfates, mono- and/or dialkyl sulfosuccinates, fatty acid isethionates, fatty acid sarcosinates, fatty acid taurides, fatty acid glutamates, alpha-olefin sulfonates, ether carboxylic acids, alkyl oligoglucosides, fatty acid glucamides, alkylamidobetaines, amphoacetals and/or protein fatty acid condensates, preferably based on wheat proteins.

It is one preferred object of the present invention to combine the cationic surfactants following formula (I) with one or more co-surfactants, used as secondary emulsifiers, and described before to provide a surfactant package suitable of producing microemulsion containing 3 to 50 wt % and more preferred of 5 to 45 wt % of terpenes.

Such a package can comprise of the cationic surfactant of formula (I) and one or more secondary emulsifier(s) in a weight ratio of 2:3 to 2:1. Preferred secondary emulsifiers are selected from alkanolamides such as cocodiethanolamine (for example COMPERLAN® COD—Cognis); amine oxides such as cocamidopropylamine oxide (for example DEHYTON® CAW—Cognis); salts of linear alkylbenzene sulfonate (for example CALIMULSE® PRS—Pilot Chemical).

Preferred combinations encompass the cationic emulsifiers according to formula (I) together with alkyl(oligo)glycosides, and ethoxylated linear fatty alcohols.

In a preferred embodiment the aqueous microemulsion compositions comprise:
about 1-25 wt % of a cationic compound according to formula (I);
about 3-50 wt % of a terpene;
about 0.5-10 wt % of a non-polar solvent;
about 1-25 wt % of a secondary emulsifier; and
the remainder water and optionally other additives.

A more preferred embodiment pertains to aqueous microemulsions, comprising:
about 1-20 wt % of a cationic compound according to formula (I);
about 5-45 wt % of a terpene;
about 1-5 wt % of a non-polar solvent;
about 2-10 wt % of a secondary emulsifier; and
the remainder water and optionally other additives.

When an abrasive is present, a water-miscible solvent can be added in amounts ranging from about 1 wt % to about 10 wt %, preferably from about 3 wt % to about 7 wt %. More preferably, the water-miscible solvent is added in an amount of about 4 wt % to about 6 wt %.

The above microemulsion composition can further comprise from about 0.1 to about 0.3 wt %, based on the weight of the composition, of a thickening agent selected from the group consisting of hydroxypropyl cellulose, hydroxypropyl methylcellulose, and mixtures thereof.

A further embodiment pertains to the use of cationic surfactants corresponding to formula (I):

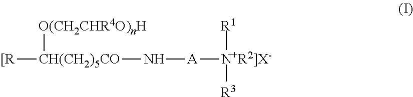

in which R is an alkyl or alkenyl group containing 11 carbon atoms, R1 and R2 independently represent hydrogen or C₁₋₄ alkyl groups, R³ is a C₁₋₄ alkyl group, R⁴ is hydrogen or a methyl group, A is a linear or branched C₂₋₆ alkylene group, n is a number from 1 to 25 and X is halogen or alkyl sulfate, as emulsifiers for aqueous microemulsions, containing terpenes.

Preferably, the compounds according to formula (I) are used in amounts of about 1 to 25 wt %, based on the total weight of the aqueous microemulsion composition.

A further embodiment of the present invention pertains to the use of compounds according to general formula (I) wherein the compound according to formula (I) is used together with a secondary emulsifier, selected from alkanolamides, amine oxides and salts of linear alkylbenzene sulfonates.

The microemulsions according to the present invention are used primarily as cleaning compositions, or as a part of a cleaning composition. Such cleaning compositions can be used in a wide variety of applications which include, but are not limited to, the removal of grease, oil, ink, chewing gum and paint from hard and porous surfaces including all kinds of natural and synthetic fabrics in both industrial-institutional and consumer applications. Examples of the disparate types of applications include, but are not limited to, the use of the cleaning compositions according to the invention as water rinsable paint brush cleaners for brushes having both natural and synthetic bristles. Another use is as a cleaner for human skin and nails such as hand and finger nail cleaner for the removal of paints, greases, glues, nail polish and the like. The cleaning compositions according to the invention can also be used for a spot cleaner for removing grease, oil and paints from carpets and rugs and as a prespotter in laundry applications for the removal of stains from fabrics. Other applications include the removal of grease such as lithium and molybdenum greases from steel and concrete surfaces such as, for example, wheel bearings or garage floors having grease and oil stained tire tracks and the like. The cleaning compositions according to the invention can also be used to clean the concrete and metal surfaces of off-shore oil drilling platforms.

To prepare the microemulsions according to the present invention normal procedures, known to the skilled worker are employed. It could be of advantage to utilize a two step method, first providing a premix, comprising the cationic compound of formula (I) together with the terpene, the solvent and other optional non-aqueous additives, and in a second step, blend it with water. During step one and two the blends are continuously mixed vigorously, with standard equipment, preferably a stirrer.

The following examples illustrate liquid cleaning compositions of the described invention. The exemplified compositions are illustrative only and do not limit the scope of the invention.

### EXAMPLES

The following nine microemulsions were prepared in accordance with the present invention:

| | Wt % |
|---|---|
| PRE-MIX 1 | |
| 1. Quaternary compound (formula (I)) | 29.4 |
| 2. CALIMULSE ® PRS (Pilot Chemical) | 17.6 |
| 3. d-Limonene, technical grade | 47.1 |
| 4. Ethanol | 05.9 |

Combine items 1-4 until clear and uniform.

| | |
|---|---|
| TERPENE MICROEMULSION 1 | |
| 1. Pre-Mix 1 | 10 |
| 2. Water | 90 |

Appearance: clear, straw yellow

| | |
|---|---|
| TERPENE MICROEMULSION 2 | |
| 1. Pre-Mix 1 | 50 |
| 2. Water | 50 |

Appearance: clear, yellow

| | |
|---|---|
| TERPENE MICROEMULSION 3 | |
| 1. Pre-Mix 1 | 90 |
| 2. Water | 10 |

Appearance: clear, yellow

| | |
|---|---|
| PRE-MIX 2 | |
| 1. Quaternary compound (formula (I)) | 25.0 |
| 2. COMPERLAN ® COD (Cognis) | 25.0 |
| 3. d-Limonene technical grade | 50.0 |

Combine items 1-3 until clear and uniform.

| | |
|---|---|
| TERPENE MICROEMULSION 4 | |
| 1. Pre-Mix 2 | 10 |
| 2. Water | 90 |

Appearance: clear, straw yellow

| | |
|---|---|
| TERPENE MICROEMULSION 5 | |
| 1. Pre-Mix 2 | 50 |
| 2. Water | 50 |

Appearance: clear, yellow

| | |
|---|---|
| TERPENE MICROEMULSION 6 | |
| 1. Pre-Mix 2 | 90 |
| 2. Water | 10 |

Appearance: clear, yellow

| | |
|---|---|
| PRE-MIX 3 | |
| 1. Quaternary compound (formula (I)) | 20.0 |
| 2. Isostearic Acid | 10.0 |
| 3. DEHYTON ® CAW (Cognis) | 20.0 |
| 4. d-Limonene, technical grade | 50.0 |

Combine items 1-4 until clear and uniform.

| | |
|---|---|
| TERPENE MICROEMULSION 7 | |
| 1. Pre-Mix 3 | 10 |
| 2. Water | 90 |

Appearance: clear, straw yellow

| | |
|---|---|
| TERPENE MICROEMULSION 8 | |
| 1. Pre-Mix 3 | 50 |
| 2. Water | 50 |

Appearance: clear, yellow

| | |
|---|---|
| TERPENE MICROEMULSION 9 | |
| 1. Pre-Mix 3 | 90 |
| 2. Water | 10 |

Appearance: clear, yellow

1. A microemulsion composition comprising:
(a) a primary emulsifier selected from a compound according to formula (I) 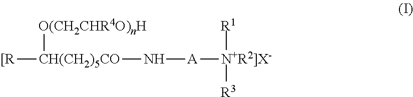
in which R is an alkyl or alkenyl group containing 11 carbon atoms, R1 and R2 independently represent hydrogen or C₁₋₄ alkyl, R³ is a C₁₋₄ alkyl group, R⁴ is hydrogen or methyl, A is a linear or branched C₂₋₆ alkylene group, n is a number from 1 to 25, and X is halogen or alkyl sulfate;
(b) a terpene;
(c) optionally, a polar solvent;
(d) optionally, a secondary emulsifier; and
(e) the remainder water and optionally other additives to 100%, all weights being based on the total weight of the composition.

2. The microemulsion of claim 1, wherein the primary emulsifier of formula (I) is derived from ethoxylated castor oil, ethoxylated ricinoleic acid or ethoxylated 12-hydroxystearic acid.

3. The microemulsion of claim 1 comprising the primary-emulsifier of formula (I), wherein R¹, R² and R³ are methyl.

4. The microemulsion of claim 1 comprising the primary-emulsifier of formula (I), wherein A is a propylene group.

5. The microemulsion of claim 1 comprising the primary-emulsifier of formula (I), wherein n is a number from 5 to 10.

6. The microemulsion of claim 1 comprising the primary-emulsifier of formula (I), wherein X is chloride or methyl sulfate.

7. The microemulsion composition of claim 1 comprising:
(a) from about 1 to about 25 wt % of a primary emulsifier selected from a compound of formula (I);
(b) from about 3 to about 50 wt % of a terpene;
(c) from about 0.5 to about 10 wt % of a polar solvent;
(d) optionally a secondary emulsifier; and
(e) the remainder water and optionally other additives to 100 wt %, all weights being based on the total weight of the composition.

8. The microemulsion composition of claim 1, wherein the primary emulsifier is present in the composition in an amount of from about 10 to about 20 wt %.

9. The microemulsion composition of claim 1, wherein the secondary emulsifier is selected from the group consisting of alkanolamides, amine oxides and salts of linear alkylbenzene sulfonates.

10. The microemulsion composition of claim 1, wherein the secondary emulsifier is present in amounts from 1 to 25% by weight.

11. The microemulsion composition of claim 1 wherein the polar solvent is selected from the group consisting of benzyl alcohol, propylene glycol n-butyl ether, n-hexanol, glycol phenyl ethers, and mixtures thereof.

12. The microemulsion composition of claim 1, wherein the polar solvent is present in amounts from 1 to 5 wt %.

13. The microemulsion composition of claim 1, wherein the terpene is selected from the group consisting of natural d-limonene, synthetic d-limonene, dl-limonene, pine oil, lemon oil, orange oil, grapefruit oil, lime oil, and bergamot oil.

14. The microemulsion composition of claim 1, wherein the terpene is present in amounts from 5 to 45 wt %.

15. The microemulsion composition of claim 1, further comprising additives selected from the group consisting of additional emulsifiers, co-surfactants, pH-adjusting agents, abrasives, biocides, dyes, perfumes, fatty acids, and thickeners.

16. The microemulsion composition of claim 1, comprising a secondary emulsifier, wherein the weight ratio of the compound of formula (I) and the secondary emulsifier is between 2:3 to 2:1.

17. The microemulsion composition of claim 1, further comprising from about 0.1 to about 0.3% by weight, based on the weight of the composition, of a thickening agent selected from the group consisting of hydroxypropyl cellulose, hydroxypropyl methylcellulose, and mixtures thereof.

18. The microemulsion composition of claim 1 in the form of an oil-continuous microemulsion.

19.-20. (canceled)

21. A method of preparing terpene-containing microemulsions comprising the step of adding one or more cationic surfactants of formula (I): 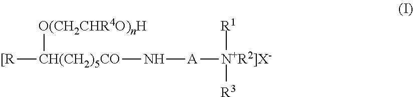
in which R is an alkyl or alkenyl group containing 11 carbon atoms, R1 and R2 independently represent hydrogen or C₁₋₄ alkyl, R³ is a C₁₋₄ alkyl group, R⁴ is hydrogen or methyl, A is a linear or branched C₂₋₆ alkylene group, n is a number from 1 to 25, and X is halogen or alkyl sulfate,
to a mixture of one or more terpenes to provide a pre-mix, and;
mixing the pre-mix with water.

22. The method of claim 21, wherein the pre-mix further comprises a secondary emulsifier selected from the group consisting of alkanolamides, amine oxides and salts of linear alkylbenzene sulfonates.
